(19) United States
(12) Patent Application Publication
(10) Pub. No.: US 2004/0105345 A1
(43) Pub. Date: Jun. 3, 2004

(54) Moon glow illuminated watch calendar

(76) Inventor: Kevin Kouch, Lawrence, NY (US)

Correspondence Address: Donald W. Meeker, Patent Agent, 750 La Playa, #512, San Francisco, CA, 94121, US

(21) Appl. No.: 10/307,059

(22) Filed: Nov. 29, 2002

(51) Int. Cl. G04B 19/20; G04B 19/24

(52) U.S. Cl. 368/37

(57) ABSTRACT

A long-lasting illuminated calendar designed for analog watches. A calendar date disk with see-through numbered indicia corresponding to sequential calendar days is mounted above a main plate which moves relative to the calendar disk at the rate of one date indicia per day. The illumination is provided by a sealed glass tube with a luminescent coating inside which is permanently activated, preferably by a limited quantity of tritium gas. The sealed glass tube is positioned in a recess formed in the watch plate. The light emitted from the gas tube projects through the transparent or translucent indicia in the calendar date disk.

### BACKGROUND OF THE INVENTION

1. Field of the Invention

The present invention relates to illumination for watches and in particular to a long life gas light illumination tube to light up calendar date numbers on the dial of an analog watch.

2. Description of the Prior Art

While there are many illuminated watches especially digital watches, and the time is always the primary thing which is illuminated, analog watches are not often lighted unless the hands have a substance on them which glows in the dark after being exposed to light. The calendar dates of analog watches are never illuminated. A major reason for the lack of illumination in analog watches is the lack of a power source in the analog watches. Digital watches all have a power source, the battery, so it is easy to attach a light source which may be powered by the existing battery.

U.S. Pat. No. 4,205,522, issued on Jun. 3, 1980 to Takami, shows a liquid crystal display device, especially, for use in a liquid crystal display watch is disclosed, which is provided with a liquid crystal display element and a reflector comprising a luminescent phosphor, and only in a limited partial area of the reflector corresponding to a specified display portion which should be visible in the dark or at night in the whole time display area of the liquid crystal display element, the luminescent phosphor includes a radioactive nuclide such as promethium (.sup.147 Pm) or tritium (.sup.3 H).

U.S. Pat. No. 4,243,303, issued on Jan. 6, 1981 to Enomoto, illustrates an illuminating device provided adjacent the liquid crystal display device of an electronic timepiece having a light emitting element composed of tritium (.sup.3 H). The light emitting element is sealed with a resin without hydrogen atoms, such as chlorotrifluoroethylene resin or polytetrafluoroethylene for preventing the leakage of 3H of tritium.

U.S. Pat. No. 4,276,633, issued on Jun. 30, 1981 to Takami, discloses a self-luminescent light source for a liquid crystal display watch characterized by comprising a fluorescent substance layer which has a light reflectivity and which contains a radioactive substance in at least a part thereof, a reflective layer which is disposed on one surface of the fluorescent substance layer and which serves to reflect and scatter fluorescence from the fluorescent substance layer, a case which is disposed on the side of the reflective layer remote from the fluorescent substance layer and which serves to perform shielding from radiation given out from the radioactive substance, and a cover which is disposed on the side of the fluorescent substance layer remote from the reflective layer and which serves to absorb the radiation given out from the radioactive substance and to transmit the light from the fluorescent substance layer.

U.S. Pat. No. 5,426,621, issued on Jun. 20, 1995 to Akasaka, indicates a luminous dial plate structure for watches, relatively high in luminance, sufficiently long in visual time and abundant in ornamental effect. The dial plate structure is composed of a lower plate and an upper member. The lower plate is made of a metal such as brass. The upper surface of the lower plate is coated with a phosphorescence-maintaining luminous agent made of a rare-earth element metal oxide. The surface of phosphorescence-maintaining luminous agent is coated with clear lacquer serving as a sealing material. The upper member is made of a thin transparent or translucent material, on which a time indication scale is provided. The upper member is bonded through an adhesive onto the upper surface of clear lacquer. In a bright place the dial plate shows such an indication that the time indication scale on the upper member is directly seen, while in a dark place the phosphorescence-maintaining luminous agent illuminates the upper member from the back to make the time indication scale visually observed as black shadows.

What is needed is a long-life source of illumination which is operable without batteries to light up a calendar dial on analogue watches .

### SUMMARY OF THE INVENTION

A primary object of the present invention is to provide a light for calendar dates on a watch.

Another object of the present invention is to provide light for calendar date produced preferably by a tritium gas activating a luminescent interior coating on the glass of a gas light, which creates a long-lasting illumination.

One more object of the present invention is to provide illumination produced by a gas light for the calendar date on an analog watch without batteries.

In brief, the idea is centered on the use of a sealed glass tube with a luminescent coating inside which is permanently activated by a limited quantity of tritium gas. A recess is formed in the main plate movement and the gas glass tube placed inside of the recess. A calendar date disk with see-through numbers is positioned on top of the main plate movement, the two moving relative to each other. The light emanating from the gas tube can then be projected through the translucent date indicia in the date disk making the calendar date externally visible.

An advantage of a light for a calendar date would be to be able to view the current date of the month in the dark.

An advantage of a long-lasting light for a watch would be not having the inconvenience of replacing batteries periodically.

Another advantage of a long-lasting light for a watch would be not having the cost of replacing batteries.

An advantage of a light for an analog watch without batteries is to be able to illuminate the calendar date.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is an exploded perspective view showing the calendar disk aligned for mounting on the watch plate as wall as an enlarged view of the gas light with an arrow indicating the location of the gas light in the watch plate;

FIG. 2 is a cross-sectional view showing the calendar disk mounted over the watch plate and the light emanating from the gas light shining through the current date on the calendar disk;

FIG. 3 is a cross-sectional view of the gas light showing the sealed glass tube, the luminescent coating on the interior of the tube, and the tritium gas within the tube.

### BEST MODE FOR CARRYING OUT THE INVENTION

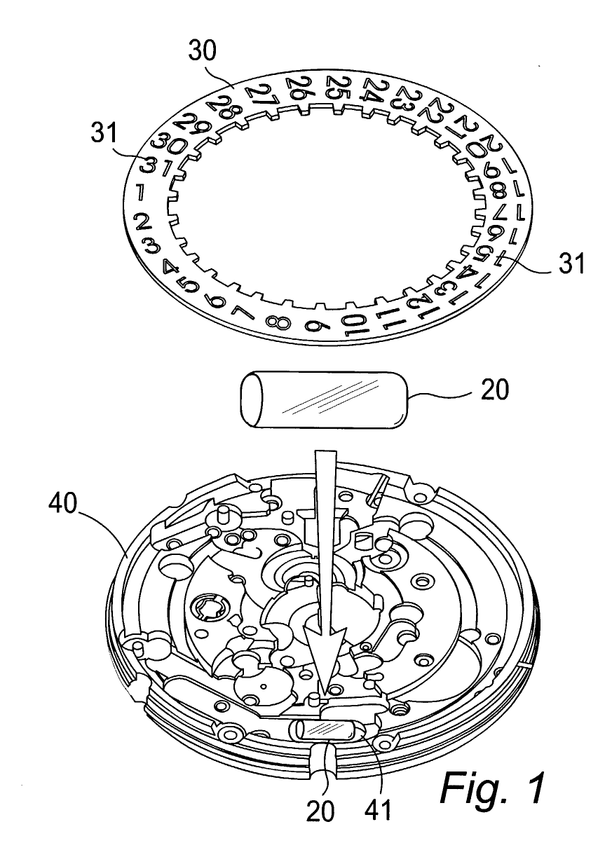

In FIGS. 1-3, a long lasting gas light 20 illuminates a calendar date number 31 on a calendar disk 30 of an analog watch.

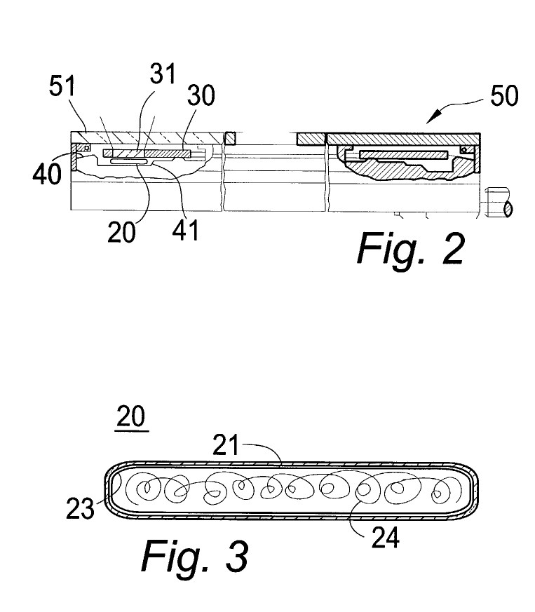

In FIG. 3, the long-lasting gas light source 20 is created by a sealed glass tube 21 having a luminescent coating 23 on the inside of the glass and filled with a limited quantity of gas 24, preferably tritium gas which is capable of illuminating the luminescent coating 23 to generate a light emanating from the sealed glass tube 21. The tritium gas 24 produces a long term illumination in the luminescent coating 23 without the need for a battery. This gas light 20 is placed inside a recess 41 formed within a watch plate 40, inside a watch casing 50, as seen in FIGS. 1 and 2.

A calendar disk 30 has a series of translucent or transparent calendar date indicia 31 positioned around the disk 30, which indicia are illuminated by the light (indicated by rays in FIG. 2) emanating from the gas light 20. The calendar disk 30 is positioned over the watch plate 40 underneath an outside watch dial 51. There is a relative movement between the calendar disk 30 and the watch plate 40, at the rate of one calendar date indicia 31 per day. While either the calendar disk 30 or the watch plate 40 may be movable, in this preferred embodiment, each day the movement of the watch plate 40 positions the sealed glass tube 21 under the current date indicia 31, makes the current calendar date illuminated and thus externally visible.

In practice, the recess 41 is formed in a movable watch plate 40 and the gas light 20 placed in the recess with the calendar date disk 30 mounted in a stationary position above the watch plate 40. The watch works inside the watch turns the watch plate so that each day the appropriate date number 31 on the calendar disk 30 is illuminated by the gas light 20.

It is understood that the preceding description is given merely by way of illustration and not in limitation of the invention and that various modifications may be made thereto without departing from the spirit of the invention as claimed.

What is claimed is:

1. A gas light device for illuminating a calendar date number on a watch, the device comprising:
a sealed glass tube having a luminescent coating on the inside of the sealed glass tube;
a quantity of gas inside the sealed glass tube which gas is capable of illuminating the luminescent coating to generate a light emanating from the sealed glass tube;
a watch plate within a watch casing, the watch plate having an opening therein to receive the sealed glass tube positioned therein;
a calendar disk having a series of calendar date indicia positioned around the disk, the indicia being capable of illumination by the light emanating from the sealed glass tube, the calendar disk capable of being positioned over the watch plate and the calendar disk and watch plate being capable of relative movement at the rate of one calendar date indicia per day so that each day one of the calendar date indicia indicating the current date is positioned over the sealed glass tube and is the indicia is illuminated by the light emanating from the sealed glass tube to be externally visible for reading the calendar date.

2. The device of claim 1 wherein the gas is tritium gas.

3. The device of claim 1 wherein the calendar disk indicia are translucent so that the light emanating from the sealed glass tube shines through the indicia.

4. The device of claim 1 wherein the calendar disk indicia are transparent so that the light emanating from the sealed glass tube shines through the indicia.

5. The device of claim 1 wherein the watch is an analog watch with a watch movement mechanism capable of creating the relative movement between the watch plate and the calendar disk.

6. The device of claim 5 wherein the watch plate moves relative to the calendar disk.
